(19) United States
(12) Patent Application Publication
(10) Pub. No.: US 2023/0310905 A1
(43) Pub. Date: Oct. 5, 2023

(54) MULTI-FUNCTIONAL CLAMP ACCESS TOOL

(71) Applicant: Jason Allen, Kelso, WA (US)

(72) Inventor: Jason Allen, Kelso, WA (US)

(21) Appl. No.: 17/713,653

(22) Filed: Apr. 5, 2022

(51) Int. Cl. A62B 3/00; B25F 1/00

(52) U.S. Cl. CPC A62B 3/00; B25F 1/003; B25B 5/04

(57) ABSTRACT

A multifunctional clamp access tool adaptable for use in diverse rescue scenarios including a spring clamp having a pair of arms, each having jaw members with grip ends extending to handle ends. The pair of arms are pivotally coupled at a spring point such that the grip ends are forcibly separable into an open position when pressure is applied to the handle ends and release of the handle ends releases the spring joint so as to compress the grip ends in abutted alignment and an inner surface between one of the grip ends. An angled offset grip portion between at least one of the grip ends and the spring point form a clearance space are configured to span a side edge of a door such that the grip end and the offset grip portion contact surfaces are offset from a transverse plane between opposing adjacent front and rear door faces. At least one handle end is tapered in a wedge and includes recesses. Opposed handle ends and a proximate aperture provide a peg spanner wrench and a lip protruding at an acute angle from a grip end provide a lug spanner wrench for loosening, tightening or otherwise manipulating a fire hydrant or hose.

### FIELD OF THE INVENTION

The present invention pertains to rescue tools for use by firefighters and other first responders to conduct emergency operations.

### BACKGROUND OF THE INVENTION

Firefighters, among other first responders, are responsible for rapid and resourceful responses to many diverse emergency situations often involving rescues of entrapped persons in precarious and sometimes life-threatening situations. The numerous and varied circumstances entail an arsenal of tools to perform a broad range of rescue operations, including for example, medical ailments, accidental injuries, or being subject to an existing or impending hazard, such as a fire or radioactive or chemical intrusion. Emergency situations very often require use of specialized tools which can cause damage. In many emergency situations including fires, tools to open locked doors. This is particularly needed when responding to fire alarms, requiring the firefighter to survey and search all rooms of a building for fire, trapped individuals, and for activated smoke or hear detectors or activated fire alarm pull stations.

The nature and extent of danger, strife, injury and hazard encountered by first responders, particularly fire rescue workers is typically unpredictable and rapidly evolving. In the face of mounting numbers of emergency calls and rescue operations and resulting injury and devastation due to various causes including natural disasters such as fires, tornadoes, blizzards, hurricanes and earthquakes, violence, accidents among other hazardous conditions encountered by first responders, the need for swift and sure rescue response is widespread.

Expeditious extrication and abatement of a hazardous condition is imperative to many rescues. Due to the multifarious types of emergencies encountered by a first responder and the high risk, and potential rapid deterioration of an injured patient or a hazard such as a fire or poisonous gas, rapid and ready access to a range of rescue tools is indispensable to addressing the hazard and extracting a victim. For example, in vehicular accident emergencies, rescue and treatment of an injured victim entails extrication from a vehicle with doors damaged, nonfunctional door handles. Conventional tools and techniques include breaking vehicle windows and cutting seatbelts, expedited by appropriate tools. Similarly, expediting extrication of entrapped victims of fire, flood, violent assaults, or other dangers entails employing tools for mitigating the hazard and entry to a space often secured by a locked door. It can thus be readily seen that providing a fire fighter or other first responder with a rescue tool enabling quick and smooth access to and abatement of the emergency situation is key to providing effective responses to the many and diverse types of emergencies encountered by first responders.

In the past, firefighters had to carry numerous different rescue tools need to be suitably prepared for the many and diverse potential tasks involved in rescue operations. Such tools are heavy, bulky, awkwardly configured. Storing, carrying, retrieving and switching between the tools often takes valuable time needed for a swift and smooth rescue operation. As a result, unwieldy or unavailability of requisite access or mitigation may delay response times and potentially cripple rescue and remediation of emergencies that could involve life-threatening emergencies. Further exacerbating the need for facile rescue tools is the ongoing shortage of first responders rendering enhanced speed and agility of rescue worker essential to rapid and effective execution of rescue operations.

U.S. Pat. No. 10,912,957drawn toward a multifunctional rescue tool provides multiple devices, including wrenches for on/off valves, opening caps on water or fire retardant reservoirs and tools to access locked or blocked doors and clear passageways enhancing first responder access and mitigation of hazards. The patented multifunctional rescue tool includes a right-angle blade to enable disengagement of a spring lock that a straight blade or even rigid card inserted in the gap between the door and frame cannot reach.

Although this and other rescue tools facilitate expeditious rescue, problems delaying entry through locked doors and keeping doors and passageways open during a rescue operation remain. For example, there is no facile mechanism for swift prying of a gap between a door side edge adjacent to the lock and door frame to insert lock releasing blade or to impede automatic door closing mechanisms and thereby enhance escape of poisonous fumes as well as trapped victims in a burning structure. Further impeding rescue is an efficacious tool for ready grasp of a water main pipe cap or reservoir tank.

Due to the rapidly expanding scope and number of emergencies, there is a persisting and urgent need for a compact yet adaptable and facile rescue tool having multiple and diverse functionalities commensurate to the variable extent of emergencies confronting fire fighters and other first responders during rescue operations that is capable of wedging doors, windows and mechanisms blocking access by first responders to spaces, water and fire retardant pipes and reservoir and similar secured entryways and agents.

### SUMMARY OF THE INVENTION

Such and other drawbacks and shortcomings of prior art rescue tools heretofore unsolved are addressed by the present invention's multi-purpose clamp access tool that is designed and configured for use in a variety of emergency situations. One embodiment of the multi-purpose rescue tool includes opposing first and second jaw members joined about a pivotal axis for a spring damp. The jaw members are configured to define a pair of pliers, such as a lineman's pliers, needle nose pliers, or other suitable pliers. Other took and features of various embodiments include a clamp end, a spanner lug wrench, a spanner peg wrench and a wedge end imparting advantages of a compact, facile and adaptive multi-functional rescue tool.

The compact and streamlined configuration of this clamp access tool facilitates ready portability. For example, it may be readily carried in a firefighter's turnout gear, uniform pocket, or medical bag. Various embodiments are adaptable to multifarious uses. Such uses include, for example, a door wedge for opening a gap to insert a blade to disengage a lock, a clamp to keep a door or window from slamming shut and possible engaging the latch, gripping lids or holding back materials to clear or prevent blocking of a passageway to expedite access to a building as well as facilitate venting of smoke, poisonous fumes and escape of victims from a hazardous area during a rescue operation.

The multifunctional clamp access tool according to the present invention includes a spring clamp having a pair of arms having corresponding jaw members with corresponding grip ends and respective first and second handles that extend in a contiguous plane along a generally longitudinal axis. The pair of jaw members are configured for swinging movement toward and away from each other about the axis of a pivot, such that the working end portions open/close. The opposing inner surfaces or faces may include a ribbed portion or ridges for gripping, turning, twisting, and rotating an object removably disposed between the working end portions. The pair of arms are pivotally coupled at a spring point such that the grip ends are forcibly separable into an open position when pressure is applied to the handle ends and release of the handle ends releases the spring joint so as to compress the grip ends in abutted alignment.

A feature of various embodiments of the present invention includes a flange or lip disposed at an outward angle from at least one of the grip ends. The flange is configured to form a notch for employing as a lug wrench for coupling with a protuberance such as a lip of a lug, to thereby loosen hydrant and water main valves and caps as well as hose connections and appliances for firefighting. The angle formed between the outer surface of the respective grip end and the lip can range between 45 and 90 degrees.

Embodiments of this invention also include handle ends configured for multiple functionalities including a spanner peg wrench dimensioned for loosening hydrant and fire hose connections and appliances for firefighting. An aperture dispose proximate to a handle end configured for receiving a peripheral peg protruding from a cap, couplings or valves provides a spanner peg wrench whereby seating a peg within the aperture provides resistance to slippage enabling a strong grip for expeditious loosening, tightening and otherwise manipulating caps, couplings, connectors and valves of hydrants, water hoses and mains as well as other fittings, such as oxygen tank or natural gas valves.

A further feature of the various embodiments is provided by configuring the pair of arms so that their inner facing surfaces between the grip end and the spring point form a clearance space dimensioned to span a width edge of a door. In various embodiments of the present invention, at least one jaw member includes an angled portion between the grip end and the spring point wherein an offset grip portion is configured for receiving corresponding a corner adjoining a door edge and adjacent door face when a grip end and offset grip portion of present clamp access rescue tool are engaged with corresponding contact surfaces of adjacent front and rear door faces. The latter configuration enables the door edge to be securely held inside the inner surfaces of the jaw members when the grip ends compress opposing front and back surfaces of the door.

A particular efficacy of this clamp access tool is provided by gripped engagement of a portion of the hinge side edge of a door between opposed inner surfaces of the jaw member of opposed door faces adjacent to the hinge side edge whereby an elbow of the angled jaw member is wedged between the hinge side edge the door jamb. Such gripped engagement is enabled by placing an inner facing surface of a grip end of the other jaw member in abutted contact with an adjacent front surface of the door and inserting the other jaw member between the door jamb and the opposing adjacent portion of the front door face to thereby clamp an inner facing surface of an offset grip portion spaced back from a grip end of one of the jaw members in abutted contact with an adjacent portion of the rear door face is stepped back or offset from the contact surface a front surface of the door abutting an inner facing surface of a grip end of the other jaw member. The resulting offset of abutting contact surfaces of the opposed inner facing surfaces of the grip end and offset grip portion provides several advantages. In particular, the corresponding offset compression trajectories of the offset inner facing contact surfaces secures the grip ends in clamped engagement position for a prolonged period. Wedging of the angled member between a hinged door jamb and a door side edge such that the offset grip portion is clamped against an adjacent door face while an opposing grip end is compressed against an opposing door face provides a further advantage of keeping the door propped in an open position.

A yet further functionality of the present clamp access tool aperture includes deploying an aperture disposed in an arm member to anchor a line for retracing a return path to a doorway or other strategic point of entry or safe harbor, when obstructions, low visibility conditions and/or mazed pathways shroud the way back. The resulting tether may be deployed by tying off or otherwise securing an anchor end through the aperture and attaching an opposing lead end to the gear of a fire fighter, releasing the lead line while scanning a space encroached by fire or other danger provides the firefighter with a palpable lead line for navigating a path back to the access door. Such a tethered lead line is an essential tool enabling safe passage back to an escape or access route in low visibility environments commonly encountered during rescue operations, such as caused by smoke, power interruptions or floating debris, and nightfall.

A still further feature of the embodiments of the present invention is a wedge end formed by tapering a least one handle end of the clamp access tool. The wedge tool can be used to pry or prop open windows, doors and closed lids. Recesses and/or ridges may be transversely disposed one or both opposed inner and outer surfaces of the wedge end to enhance traction. A particular utility facilitating entry through a tight-fitting locked door is provided by shoving the wedge end between a door side edge and door jamb so a blade to disengage a spring lock can then be inserted.

Further features of the multi-functional rescue tool according to the present invention thus provide, without limitation, a streamlined and compact clamp, lead line tether, door prop, wedge and spanner wrench tool adaptable for use in diverse rescue scenarios that is readily deployed in confined spaces. The multi-functional access tool of the present invention thus provides a strategic combination of essential features and functionalities deployed in rescue operations enabling rescue worders to expeditiously execute rescue operations, including expediting rapid entry and egress of rescue workers, victims, hazardous materials such as, for example, smoke, fumes, toxic gases, in a single compact tool that is easily carried in the gear of firefighters and other first responders.

### BRIEF DESCRIPTION OF THE DRAWINGS

FIG. 1 is a right side view of an embodiment of the multifunctional clamp access tool of the present invention in a closed position when not in use.

FIG. 2. is a left side view of the illustrated embodiment of the multifunctional clamp access tool

FIG. 3 is a top view of the of the illustrated embodiment of the multifunctional clamp access tool

FIG. 4 is a bottom view of the of the illustrated embodiment of the multifunctional clamp access tool

FIG. 5 is a rear perspective view of the illustrated embodiment of the multifunctional clamp access tool.

FIG. 6 is a front view of the illustrated embodiment of the multifunctional clamp access tool.

FIG. 7 is a rear view of the illustrated embodiment of the multifunctional clamp access tool.

FIG. 8 illustrates this multifunctional clamp access tool in use as a lug spanner wrench.

FIG. 9 illustrates this multifunctional clamp access tool in use as a peg spanner wrench.

FIG. 10 illustrates a use of the multifunctional clamp access tool in use to prop a door open.

### DETAILED DESCRIPTION OF A PREFERRED EMBODIMENT

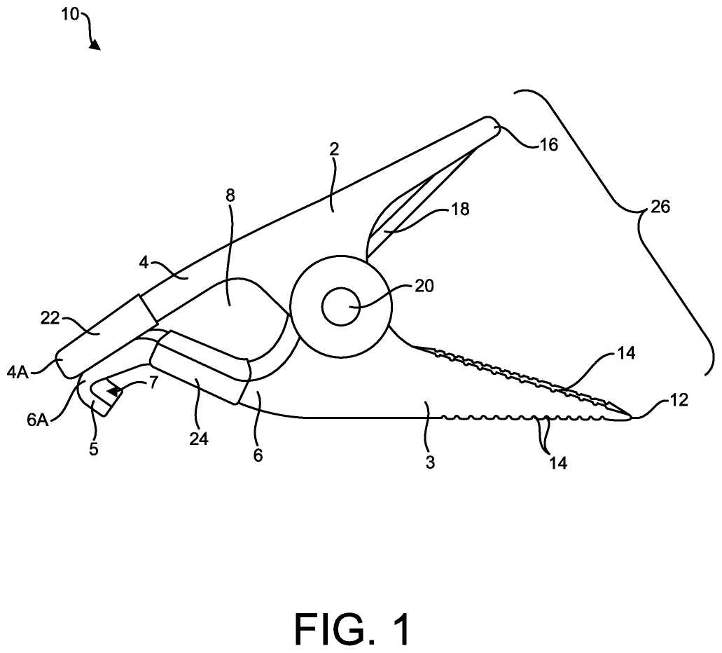

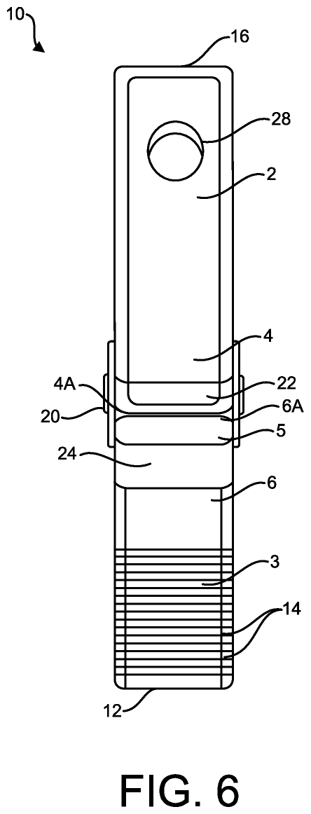

Embodiments of the multifunctional clamp access rescue tool according to the present invention such as depicted in FIGS. 1-10 is a multi-functional clamp access rescue tool 10. As illustrated, this embodiment of the present invention features a spring clamp including a first arm 2 and a second arm 3 with a respective contiguous outer surface and inner surface. First arm 2 and second arm 3 have a first jaw member 4 with grip end 4A and a second jaw member 6 with a grip end 6A and a first handle end 16 and a second handle end 12. First arm 2 and second arm 3 are pivotally coupled at a spring point 20 such that first grip end 4A and second grip end 6A are forcibly separable into an open position when pressure is applied to first handle end 16 and second handle end 12 and the spring joint 20 compresses coextensive planar inner surfaces of first grip end 4A and second grip end 6A in abutted alignment.

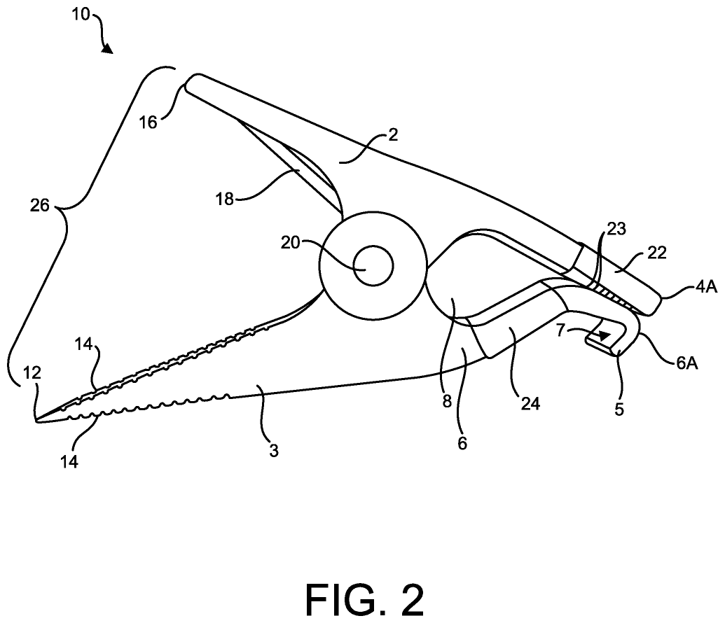

Grip ends 4A and 6A include corresponding coextensive planar inner surfaces that pivotally open and dose to form a working clamp. Grip cap 22 affixed on grip end 4A may be composed of a skid resistant material enhances friction and grip of the working damp to thereby more firmly grasp an object secured between first grip end 4A and second grip end 6A. The skid resistant material of grip cap 22 and a grip wrap about offset grip portion 24 can be composed of a nylon that may include fractured glass, a polymer, rubberized or other suitable material. Now referring to FIG. 2, an inner portion of the surface of grip cap 22 and grip wrap of offset grip portion 24 include ribbed portion 23. In various alternative embodiments, surfaces of grip end 4A and offset grip portion 24 may be textured or provided with another type of protective layer to further improve gripping action,

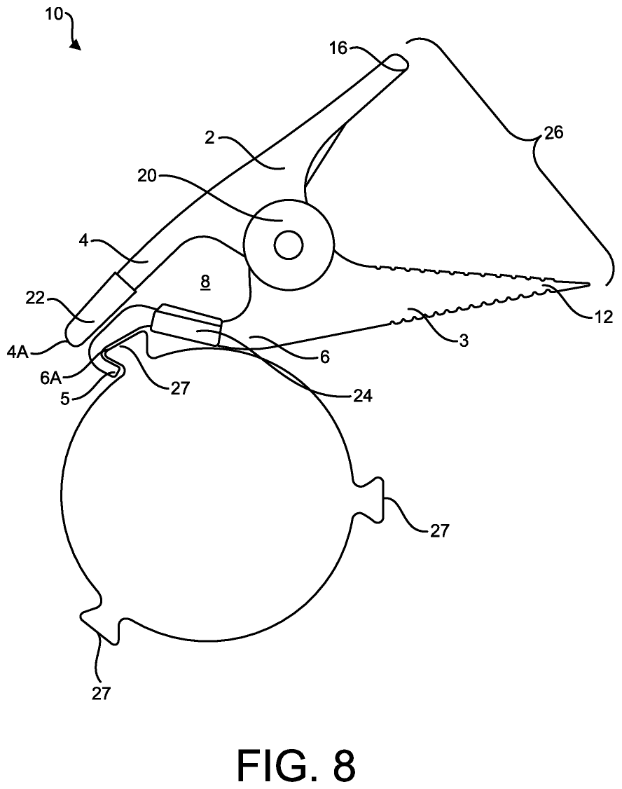

Now referring to FIG. 8 schematically depicting a function of a spanner lug wrench 5 illustrated in FIGS. 1 and 2 is provided by an acute outwardly angled flange so as to form a notch space 7 capable of coupling with a lug 27 for loosening or otherwise manipulating a fire hydrant cap, coupling or other connector or appliance.

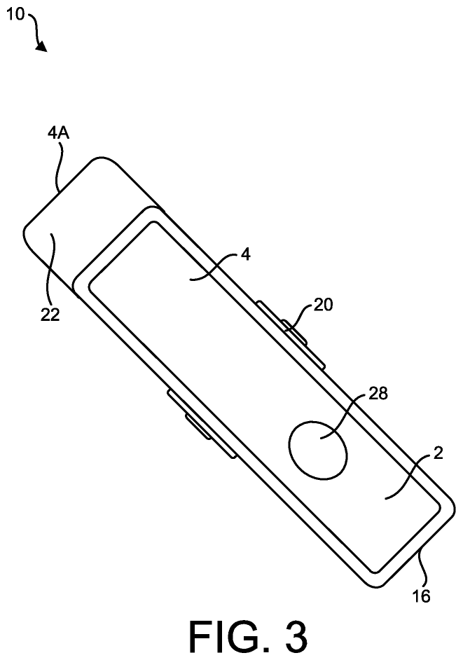

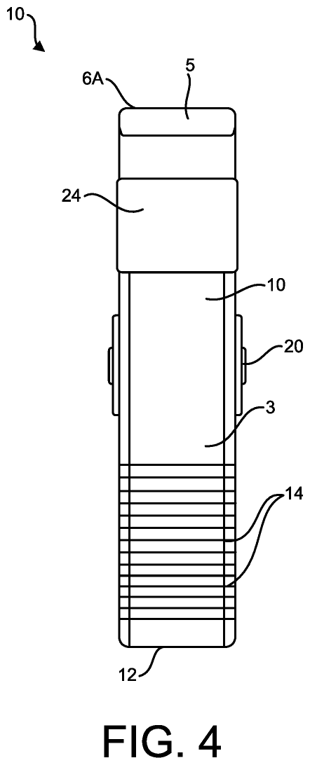

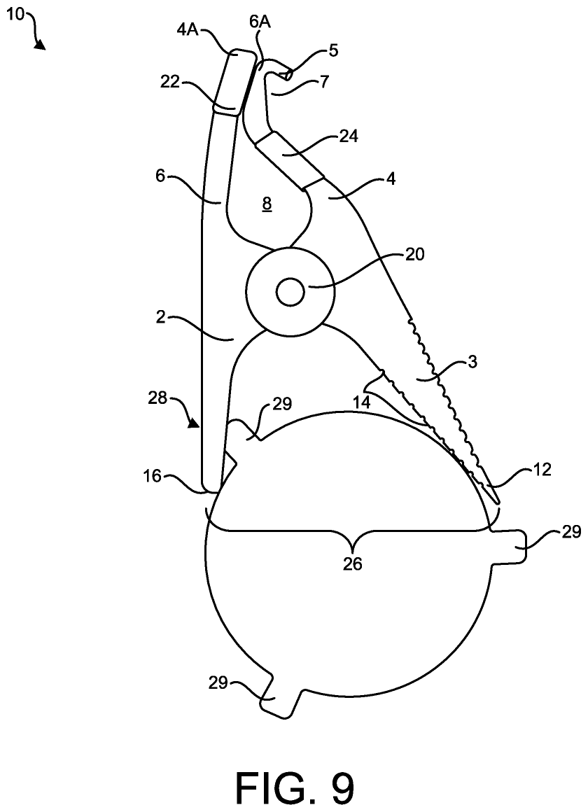

A yet another feature of clamp access tool 10 is peg spanner wrench 26 illustrated in FIGS. 3, 4 and in use to manipulate by loosening a fire hydrant cap having a peripheral peg 29 provided by gripped pairing of handle ends 12 and 16 about a fire hydrant cap or other coupling such that an aperture 28 disposed on a portion of first arm 2 between spring joint 20 and handle end 16 is coupled with peg 29 in FIG. 9. Traction for gripping a connector or cap for a fire hose or appliance is provided by transverse recesses 14. Traction may be further enhanced by including ridges between alternating recess 14.

Spanner peg wrench 26 and spanner lug wrench 5 are adaptable to loosen, shut off or otherwise manipulate various couplings, caps and valves for hydrants, hoses, water pipe caps, natural gas lines and other appliances conveniently thereby providing two of the most commonly used spanner wrench tools used to mitigate hazards encountered in rescue operations.

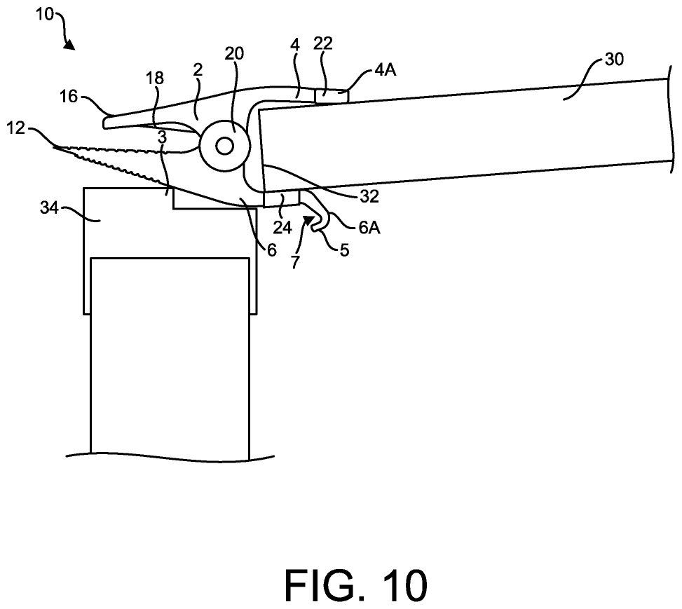

Another useful feature provided by clamp access tool 10 is a clearance space 8 configured within opposed inner surfaces of first jaw member 4 and second jaw member 6 between grip ends 4A and 6A and spring point 20. Now referring to FIG. 10, a particularly efficacious use of clamp access tool 10 illustrated in a schematic cross-section representation of coupling of first jaw member 4 and second jaw member 6 to a door 30 and door jamb 34 enables keeping a door 30 propped open when first jaw member 4 and second jaw member 6 are clamped about front and rear door faces adjacent to a portion of a hinged side edge 32 of a door 30. Such clamped engagement is enabled by placing an inner facing surface of grip end 4A of first jaw member 4 in abutted contact with an adjacent front surface of door 30 and inserting the other jaw member 6 between the door jamb 34 and opposing adjacent portion of a rear face of door 30 to thereby clamp an inner facing surface of offset grip portion 24 spaced back from a grip end of one of the jaw members in abutted contact with an adjacent portion of the rear door face. As shown, second jaw member 6 is angled to configure a clearance space 8 dimensioned to receive door side edge 32 when an inner surface of offset grip portion 24 and an inner surface of grip cap 22 simultaneously compress corresponding adjacent opposed surfaces of the front and rear door faces of door 30. Still referring to FIG. 10, second jaw member 6 is configured for insertion between door side edge 32 and door jamb 34 to thereby enable positioning offset grip portion behind and thereby grip a rear face of door 30 to maintain door 30 in a wide-open position. A further feature provided by the configuration of first jaw member 4 and second jaw member 6, including the substantially perpendicular angling of offset grip portion 24. As FIG. 10 illustrates, the respective abutting contact surfaces of grip end 4 and offset grip portion 24 with corresponding portions of front and rear faces of door 30 are offset from a transverse axis of the front and rear faces of door 30.

As detailed above, such offset compression of the opposed inner facing surfaces of the grip imparts several advantages over conventional clamp systems. In particular, the latter configuration enables the door side edge to be securely seated within inner surfaces of the jaw members as grip end 4A and offset grip portion 24 simultaneously compress opposing adjacent front and back surfaces of the door. Such gripped engagement provided by the stepped or offset inner facing contact surfaces of grip end 4A and offset grip portion 24 maintains the grip of clamp access tool 10 upon the opposing front and back surfaces of door 30 for a prolonged period. A yet further advantage provided by such offset positioning of the contact surfaces is the efficacy of propping a door in an unlatched, open position by clamping the grip end 4A and offset grip portion 24 on adjacent opposed respective front and rear faces adjacent to hinged side edge 32 of door 30.

As described above, a further functionality of aperture 28 is provided by tethering a lead line through aperture 28 enabling return to a door whereon clamp access tool 10 is secured. An anchor end of the lead line may be directly threaded through aperture 28 and secured by a loop or other knot, or affixed to a clasp, carabiner, or other fastener coupled to aperture 28 and a releasable moveable opposing lead end may be attached by various conventional methods and fasteners to gear or a tool carried on or worn by the firefighter or other rescue worker. Releasing the lead line while scanning a space encroached by fire or other danger provides the rescue worker with a palpable lead line for navigating a path back to the access door. This tethered lead line functionality may enable safe retracement back to an escape or access route in low visibility environments commonly encountered during rescue operations, such as caused by smoke, power interruptions or floating debris and/or nightfall.

The illustrated embodiment further includes a wedge end formed by tapering of the handle end 12 of second arm 3. Among numerous functionalities of clamp access tool 10 in addition to propping a door open, wedge end 12 can be used to pry a gap facilitating entry through a tight-fitting locked door is provided by shoving wedge end 12 between a door side edge and door jamb to expand the space in order to enlarge a space for insertion of a blade to disengage a lock.

Clamp access tool 10 may be composed of any durable, rigid and preferably a heat resistant, high grade, lightweight metal, alloy or other suitable material such as, for example, stainless steel, titanium, aluminum, carbon fiber. First handle 2 and second handle 3 may be configured in various shapes and sizes so long as the overall dimensions are suitable for inserting in a pocket or other compact compartment.

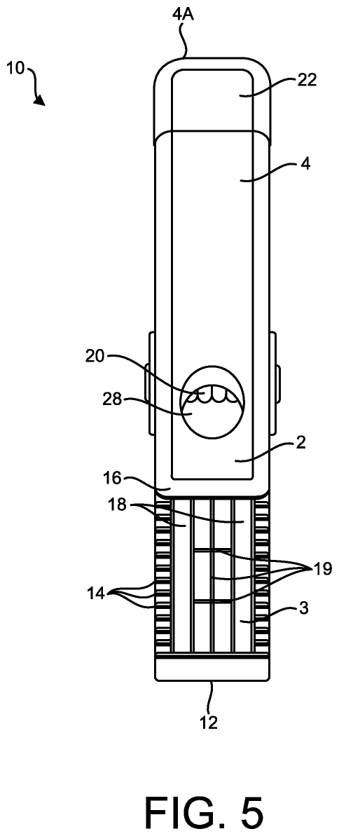

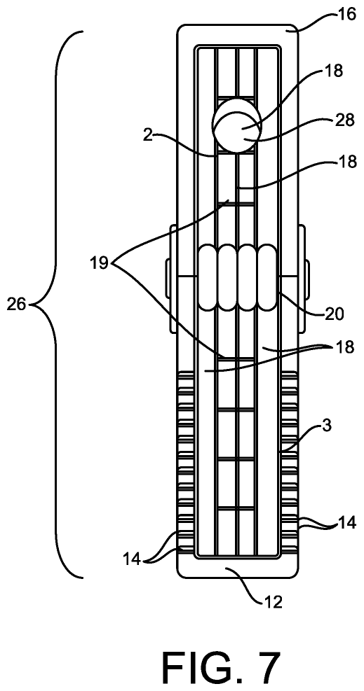

Now referring to FIGS. 5 and 7, a further feature of the illustrated embodiment include a series of cross-linked perpendicular walls forming rectangular cavities 19 lining a portion of the inner surfaces of first arm member 2 and second arm member 3. Such cross-linked construction of modules 19 bolsters the strength and stability of first arm member 2 and second arm member 3 while reducing weight and cost.

The scope of the present invention is not delimited by the literal language of this specification and the appended claims. For example, embodiments of the present invention may also include on or more aperture wrenches disposed in an arm. Such an aperture wrench can be configured in various shapes and sizes adapted to particular functionalities that could include configurations that are rounded, ovoid, teardrop, parabolic, rectangular, square, triangular, pentagonal or hexagonal or some other configuration. For example, the periphery could be rounded or teardrop shaped to loosen fasteners such as nails, screws, washers, rectangular for coupling with a typical oxygen tank valve, or hexagon shape for coupling with a natural gas tank valve. In other embodiments, the jaw members could be configured as cutters, such as wire or sheet metal cutters or a glass breaking tool. In alternative embodiments, the clamp may be ratcheted. It is further contemplated that the multi-functional rescue tool could include protuberances that could be used for allen wrenches, elevator access keys, hooks and other known rescue tools. Hence, modifications, permutations, additions and sub-combinations are embraced by the spirit and scope of the invention. Hence, such and other variations are included in the scope of the invention, describe, illustrated and claimed herein.

1. A multifunctional clamp access tool, comprising:
a spring clamp having a pair of arms with an inner surface and an outer surface including a corresponding pair of jaw members having a corresponding pair of grip ends extended from a corresponding pair of handle ends, wherein the pair of arms are pivotally coupled at a spring point such that the grip ends are forcibly separable into an open position when pressure is applied to the handle ends and release of the handle ends releases the spring joint so as to compress the pair of grip ends in abutted alignment, and wherein at least a portion of the inner surface between at least one of the pair of grip ends and the spring point is configured to form a clearance space for receiving a side edge of a door; and
a spanner lug wrench formed by a flange disposed outwardly from one of the pair of grip ends, wherein the flange forms an angle of less than 90 degrees from the longitudinal plane of the corresponding arm and wherein the flange is configured for coupling a lug.

2. The multifunctional clamp access tool of claim 1, wherein the handle ends are configured to form a spanner wrench, wherein at last one aperture is disposed in at least one of the handle ends, and wherein the at least one aperture is configured for coupling a protruding peg.

3. The multifunctional clamp access tool of claim 1, wherein the pair of grip ends include coextensive planar inner surfaces positioned in abutted alignment when the spring joint is released.

4. The multifunctional clamp access tool of claim 3 wherein the pair of jaw members are configured for receiving a door side edge within a clearance space between corresponding inner surfaces of the jaw members, wherein a portion of at least a portion of the inner surface of at least one of the pair of jaw members includes an angled portion between the corresponding grip end and the spring joint with an adjacent planar surface having an offset grip portion, wherein the offset grip portion is configured such that when an inner surface of the offset grip portion of the one of the pair of jaw members grips a contact surface of an adjacent rear face of the door and an inner surface of the grip end of another of the pair of jaws grips a contact surface of an adjacent front face of the door, wherein the contact surface of the adjacent rear face of the door and the contact surface of the adjacent front face of the door are offset from a transverse plane between the adjacent rear face of the door and front face of the door.

5. The multifunctional clamp access tool of claim 1, wherein at least a portion of the inner surface of at least one of the pair of grip ends includes a ribbed portion.

6. The multifunctional clamp access tool of claim 1, wherein the inner surface and the outer surface of at least one of the pair of handle ends are tapered in a wedge end.

7. The multifunctional clamp access tool of claim 6, wherein at least a portion of the outer surface of the wedge end includes a plurality of transverse recesses.

8. The multifunctional clamp access tool of claim 1, further comprising a protective layer affixed to at least a portion of the inner surface of at least one of the pair of arms.

9. The multifunctional clamp access tool of claim 4, wherein the at least a portion of at least one of the grip ends comprises a protective layer forming a grip cap affixed about at least one of the pair of jaw members adjacent to at least one grip end and a protective layer is affixed about at least a part of the offset grip portion.

10. The multifunctional clamp access tool of claim 9, wherein the protective layer is composed of a material including a member of the group consisting of a polymer, a thermoplastic polyurethane, a rubber, and a nylon.

11. A multifunctional clamp access tool, comprising:
a spring clamp having a first arm with a first inner surface and a first outer surface extending from a first grip end of a first jaw member to a first handle end and a second arm with a second inner surface and a second outer surface extending from a second grip end of a second jaw member to a second handle end, wherein the first grip end and the second grip end include coextensive inner planar surfaces, and wherein the first arm and the second arm are pivotally coupled at a spring point such that the first grip end and the second grip end are forcibly separable into an open position when pressure is applied to the first handle end and the second handle end, and release of the first handle end and the second handle end releases the spring joint so as to compress the coextensive planar inner surfaces of the first grip end and the second grip end in abutted alignment when the spring joint is released,
wherein at least a portion of the second inner surface between the grip end and the spring point of the second jaw member is configured to form a clearance space for receiving a side edge of a door when the first jaw member and second jaw member are in gripped engagement with an adjacent contact surface of a front face of the door and an opposed adjacent surface of a rear face of the door such that the contact surface of the grip end of the first jaw member grips an adjacent front face of the door and an inner offset grip portion contact surface of the second jaw member grips an adjacent rear face of the door, and wherein the contact surface between the grip end of the first jaw member and the offset grip portion contact surface of the second jaw member are offset from a transverse axis of the front face of the door and the rear face of the door.

12. The multifunctional clamp access tool of claim 11, wherein a portion of the outer surface and a portion of the inner surface proximate to the second handle end are inwardly tapered in a wedge end.

13. The multifunctional clamp access tool of claim 12, wherein the first handle end and the second handle end are configured to form a peg spanner wrench including at least one aperture disposed proximate to the first handle end or second handle end, wherein the at least one aperture is configured for coupling a protruding peg.

14. The multifunctional clamp access tool of claim 11, further comprising a protective grip cap affixed about a portion of the first grip end and a protective grip wrap affixed about at least a portion of the offset grip portion.

15. The multifunctional clamp access tool of claim 12, wherein at least a portion of the outer surface of the wedge end has a plurality of alternating transverse ridges and recesses.

16. The multifunctional clamp access tool of claim 12, wherein at least a portion of an inner surface of the wedge end and a portion of an outer surface of the wedge end has a plurality of alternating ridges and recesses.

17. The multifunctional clamp access tool of claim 15, wherein the protective grip cap and the protective grip wrap are composed of a material including a member of the group consisting of a polymer, a thermoplastic polyurethane, a rubber and a nylon.

18. The multifunctional clamp access tool of claim 15, wherein an inner surface of the protective grip cap includes a ribbed portion.
